(19) United States
(12) Patent Application Publication
(10) Pub. No.: US 2022/0102702 A1
(43) Pub. Date: Mar. 31, 2022

(54) ANODE MATERIAL AND SOLID-STATE BATTERY

(71) Applicant: TOYOTA JIDOSHA KABUSHIKI KAISHA, Toyota-shi (JP)

(72) Inventor: Masumi SATO, Gotemba-shi (JP)

(73) Assignee: TOYOTA JIDOSHA KABUSHIKI KAISHA, Toyota-shi (JP)

(21) Appl. No.: 17/484,412

(22) Filed: Sep. 24, 2021

(30) Foreign Application Priority Data
Sep. 30, 2020 (JP) 2020-164830

(51) Int. Cl. H01M 4/134; C22C 24/00

(52) U.S. Cl. CPC H01M 4/134; H01M 2004/027; C22C 24/00

(57) ABSTRACT

To provide an anode material which is resistant to deactivation even when it is exposed to an oxygen-containing gas atmosphere, and a solid-state battery using the same. An anode material for solid-state batteries that use a precipitation-dissolution reaction of lithium metal as an anode reaction, wherein the anode material is a multiphase alloy comprising a Li single phase and a Li-M alloy phase; wherein M of the Li-M alloy phase is at least one metal selected from the group consisting of Al, In and Zn; and wherein an amount of the M in the multiphase alloy is 0.90% by mass or more and 21.00% by mass or less.

### TECHNICAL FIELD

The present disclosure relates to an anode material and a solid-state battery.

### BACKGROUND

Recently, with the rapid spread of information-related devices and communication devices such as personal computers, video cameras and mobile phones, the development of batteries for use as the power source of the devices, is increasingly important. Also in the automotive industry, etc., the development of a high-power and high-capacity battery for battery electric vehicles or hybrid electric vehicles has been promoted.

Among batteries, a lithium secondary battery has attracted attention for the following reason: since lithium, which has the largest ionization tendency among metals, is used as the anode, a potential difference from the cathode is large, and a high output voltage is obtained.

Also, a solid battery has attracted attention in that a solid electrolyte is used as the electrolyte interposed between the cathode and the anode, instead of an electrolytic solution containing an organic solvent.

Patent Literature 1 discloses an anode for all-solid-state secondary batteries, comprising a covering layer which covers an anode current collector and on which lithium metal can be precipitated through a lithium alloy layer at the time of charging.

Patent Literature 2 discloses a solid-state battery in which Li or Li alloy is used as an anode and LAGP.
Patent Literature 1: Japanese Patent Application Laid-Open (JP-A) No. 2018-129159
Patent Literature 2: JP-A No. 2020-009619

Since a Li metal anode has high energy density, a solid-state battery using the anode is expected to be used as a next-generation, in-vehicle battery. On the other hand, due to its lowest redox potential, Li is highly reactive with the atmosphere. Li metal is easily deactivated by nitridation or oxidation even in a dry atmosphere, and a solid-state battery using this metal as the anode has a low capacity retention rate. When Li nitride is formed on the surface of the Li metal, the surface of the Li metal is cracked, and the deactivation of the Li metal further proceeds to the inside of the Li metal.

### SUMMARY

The disclosed embodiments were achieved in light of the above circumstances. An object of the disclosed embodiments is to provide an anode material which is resistant to deactivation even when it is exposed to an oxygen-containing gas atmosphere, and a solid battery using the same.

The anode material of the disclosed embodiments is an anode material for solid-state batteries that use a precipitation-dissolution reaction of lithium metal as an anode reaction,

wherein the anode material is a multiphase alloy comprising a Li single phase and a Li-M alloy phase;

wherein M of the Li-M alloy phase is at least one metal selected from the group consisting of Al, In and Zn; and

wherein an amount of M in the multiphase alloy is 0.90% by mass or more and 21.00% by mass or less.

The M may include Al, and the Al in the multiphase alloy may be 0.25 atomic % or more and 6.10 atomic % or less.

The M may include In, and the In in the multiphase alloy may be 0.06 atomic % or more and 1.50 atomic % or less.

The M may include Zn, and the Zn in the multiphase alloy may be 0.10 atomic % or more and 1.20 atomic % or less.

The solid-state battery of the disclosed embodiments is a solid-state battery that uses a precipitation-dissolution reaction of lithium metal as an anode reaction, the solid-state battery comprising a cathode comprising a cathode layer, an anode comprising an anode current collector and an anode layer, and a solid electrolyte layer disposed between the cathode layer and the anode layer, wherein the anode layer comprises an anode material that is a multiphase alloy comprising a Li single phase and a Li-M alloy phase;

wherein M of the Li-M alloy phase is at least one metal selected from the group consisting of Al and In and Zn; and

wherein an amount of the M in the multiphase alloy is 0.90% by mass or more and 21.00% by mass or less when the solid-state battery is fully charged.

According to the disclosed embodiments, an anode material which is resistant to deactivation even when it is exposed to an oxygen-containing gas atmosphere, and a solid-state battery using the same are provided.

### BRIEF DESCRIPTION OF THE DRAWINGS

In the accompanying drawings,

FIG. 1 is a Li—Al phase diagram;

FIG. 2 is a Li—In phase diagram;

FIG. 3 is a Li—Zn phase diagram;

FIG. 4 is a schematic cross-sectional view of an example of the solid-state battery of the disclosed embodiments;

FIG. 5 is an example of the discharge curve of an evaluation cell (C) in which the Li—Al multiphase alloy of Example 3 was used as the anode;

FIG. 6 is an example of the discharge curve of an evaluation cell (F) in which the Li—In multiphase alloy of Example 6 was used as the anode; and

FIG. 7 is an example of the discharge curve of an evaluation cell (H) in which the Li—Zn multiphase alloy of Example 8 was used as the anode.

### DETAILED DESCRIPTION

### 1. Anode Material

The anode material of the disclosed embodiments is an anode material for solid-state batteries that use a precipitation-dissolution reaction of lithium metal as an anode reaction,

wherein the anode material is a multiphase alloy comprising a Li single phase and a Li-M alloy phase;

wherein M of the Li-M alloy phase is at least one metal selected from the group consisting of Al, In and Zn; and

wherein an amount of the M in the multiphase alloy is 0.90% by mass or more and 21.00% by mass or less.

In the disclosed embodiments, the term “lithium secondary battery” refers to a battery in which at least one of lithium metal and a lithium alloy is used as an anode active material, and a precipitation-dissolution reaction of the lithium metal is used as an anode reaction. Also in the disclosed embodiments, the term “anode” means one including an anode layer.

In the disclosed embodiments, when the solid-state battery is fully charged, the solid-state battery is in a state where the state of charge (SOC) of the solid-state battery is 100%. The SOC is intended to indicate the percentage of the charged capacity with respect to the fully charged capacity of the battery, and the fully charged capacity is an SOC of 100%.

The SOC may be estimated, for example, from the open circuit voltage (OCV) of the solid-state battery.

According to the disclosed embodiments, an anode material which is resistant to deactivation even when it is exposed to an oxygen-containing gas atmosphere, and a solid battery using the same are provided.

In the anode material of the disclosed embodiments, at least one metal selected from the group consisting of Al, In, and Zn is slightly eluted in the Li metal to form a film on the surface of the Li metal, thereby suppressing a reaction with the atmosphere. Accordingly, the anode material of the disclosed embodiments is resistant to deactivation even when it is exposed to an oxygen-containing gas atmosphere, and the solid-state battery using the anode material of the disclosed embodiments has a high capacity retention rate.

The anode material is a multiphase (composite) alloy comprising a Li single phase and a Li-M alloy phase.

The M of the Li-M alloying phase is at least one metal selected from the group consisting of Al, In and Zn. In the multiphase alloy, the Li single phase and the Li-M alloy phase (M is at least one phase selected from the group consisting of Al, In and Zn) are precipitated. It is possible to determine whether the alloy is a multiphase alloy or not, by comparing the atomic % of the metal contained in the multiphase alloy with the following phase diagrams.

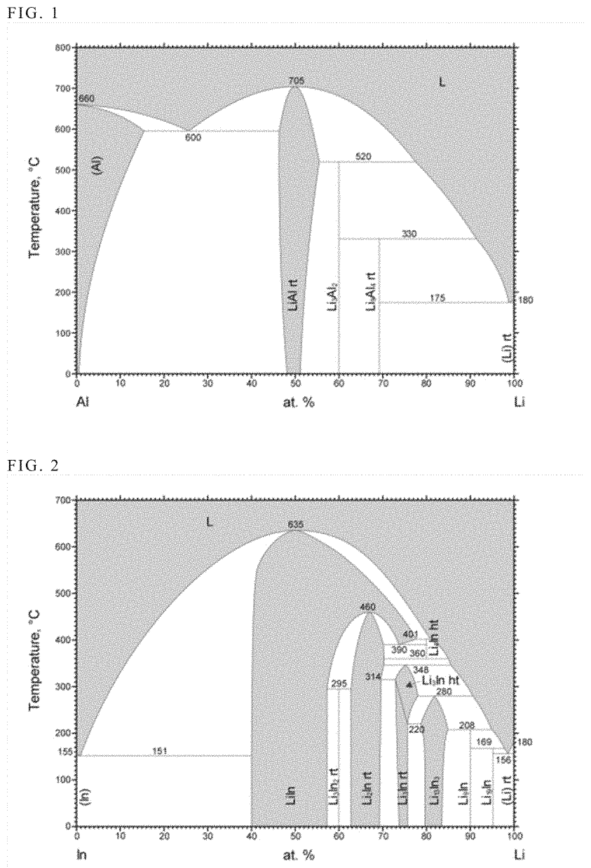

FIG. 1 is a Li—Al phase diagram.

FIG. 2 is a Li—In phase diagram.

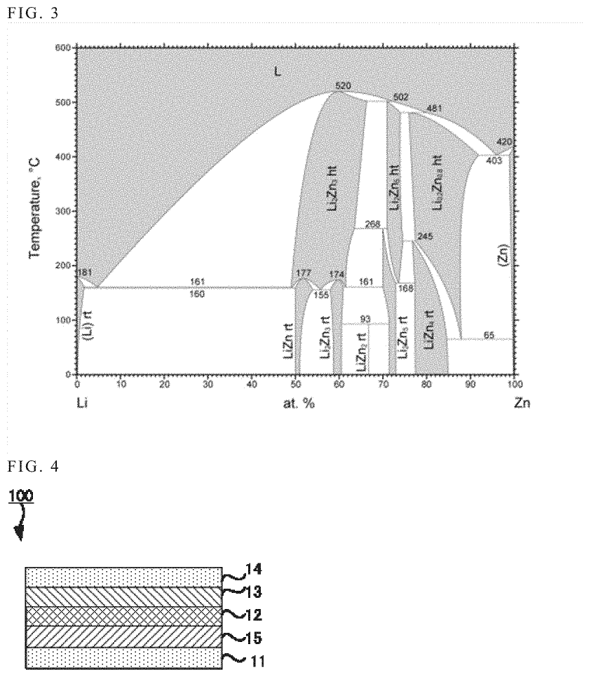

FIG. 3 is a Li—Zn phase diagram.

The amount of the M in the multiphase alloy is 0.90% by mass or more and 21.00% by mass or less. When the amount is less than 0.90% by mass, the multiphase alloy is easily deactivated when it is exposed to an oxygen-containing gas atmosphere. On the other hand, if the amount is more than 21.00% by mass, the energy density of the solid-state battery decreases.

The M includes Al, and the Al in the multiphase alloy may be 0.25 atomic % or more and 6.10 atomic % or less. This fact corresponds to that the amount of the Al in the multiphase alloy is about 0.96% by mass or more and 20.16% by mass or less.

The M includes In, and the In in the multiphase alloy may be 0.06 atomic % or more and 1.50 atomic % or less. This fact corresponds to that the amount of the In in the multiphase alloy is about 0.99% by mass or more and 20.02% by mass or less.

The M includes Zn, and the Zn in the multiphase alloy may be 0.10 atomic % or more and 1.20 atomic % or less. This fact corresponds to that the amount of the Zn in the multiphase alloy is about 0.93% by mass or more and 10.27% by mass or less.

The percentage (%) by mass of the metal M={(The molecular weight of the M)×The atomic % of the M}/{(The molecular weight of the Li)×(100−The atomic % of the M)+(The molecular weight of the M)×The atomic % of the M}×100

In this formula, the molecular weight of the Li may be set to 6.941 g/mol; the molecular weight of the Al may be set to 26.98 g/mol; the molecular weight of the In may be set to 114.818 g/mol; and the molecular weight of the Zn may be set to 65.38 g/mol.

### 2. Solid-State Battery

The solid-state battery of the disclosed embodiments is a solid-state battery that uses a precipitation-dissolution reaction of lithium metal as an anode reaction, the solid-state battery comprising a cathode comprising a cathode layer, an anode comprising an anode current collector and an anode layer, and a solid electrolyte layer disposed between the cathode layer and the anode layer,

wherein the anode layer comprises an anode material that is a multiphase alloy comprising a Li single phase and a Li-M alloy phase;

wherein M of the Li-M alloy phase is at least one metal selected from the group consisting of Al and In and Zn; and

wherein an amount of the M in the multiphase alloy is 0.90% by mass or more and 21.00% by mass or less when the solid-state battery is fully charged.

FIG. 4 is a schematic cross-sectional view of an example of the solid-state battery of the disclosed embodiments when the battery is fully charged.

As shown in FIG. 4, a solid-state battery 100 includes an anode current collector 11, a solid electrolyte layer 12, a cathode layer 13 and a cathode current collector 14 in this order, and it includes an anode layer 15 between the anode current collector 11 and the solid electrolyte layer 12.

### [Anode]

The anode includes the anode current collector and the anode layer.

### [Anode Current Collector]

The material for the anode current collector may be a material that is not alloyed with Li, such as SUS, copper and nickel. As the form of the anode current collector, examples include, but are not limited to, a foil form and a plate form. The plan-view shape of the anode current collector is not particularly limited, and examples thereof include, but are not limited to, a circular shape, an ellipse shape, a rectangular shape and any arbitrary polygonal shape. The thickness of the anode current collector varies depending on the shape. For example, it may be in a range of from 1 μm to 50 μm, or it may be in a range of from 5 μm to 20 μm.

### [Anode Layer]

The anode layer contains the anode material which is the multiphase alloy comprising the Li single phase and the Li-M alloy phase.

The anode layer may also contain a conventionally-known anode active material, as long as the anode layer contains, as a main component, the multiphase alloy comprising the Li single phase and the Li-M alloy phase. In the disclosed embodiments, the main component means such a component that the amount is 50% by mass or more of the total mass (100% by mass) of the anode layer when the solid-state battery is fully charged. The anode layer may contain only the multiphase alloy comprising the Li single phase and the Li-M alloy phase.

As the anode active material, examples include, but are not limited to, lithium metal (Li) and a lithium alloy. As the lithium alloy, examples include, but are not limited to, Li—Au, Li—Mg, Li—Sn, Li—Si, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te, and Li—At.

The thickness of the anode layer is not particularly limited. It may be 30 nm or more and 5000 nm or less when the solid-state battery is fully charged.

### [Solid Electrolyte Layer]

The solid electrolyte layer contains at least a solid electrolyte.

As the solid electrolyte contained in the solid electrolyte layer, a conventionally-known solid electrolyte that is applicable to a solid battery can be appropriately used, such as an oxide-based solid electrolyte and a sulfide-based solid electrolyte.

As the sulfide-based solid electrolyte, examples include, but are not limited to, Li₂S—P₂S₅, Li₂S—SiS₂, LiX—Li₂S—SiS₂, LiX—Li₂S-P₂S₅, LiX—Li₂O—Li₂S—P₂S₅, LiX—Li₂S—P₂O₅, LiX—Li₃PO₄—P₂S₅ and Li₃PS₄. Note that the description “Li₂S—P₂S” means a material consisting of a raw material composition including Li₂S and P₂S₅, and the same applies to other descriptions. Also, “X” of the above-described LiX indicates a halogen element. The raw material composition may contain one or two or more kinds of LiX. When two or more kinds of LiX are contained, the mixing ratio of the two or more kinds of LiX is not particularly limited.

The molar ratio of the elements in the sulfide-based solid electrolyte can be controlled by adjusting the amounts of the elements in the raw material. Also, the molar ratio and composition of the elements in the sulfide-based solid electrolyte can be measured by ICP emission spectrometry, for example.

The sulfide-based solid electrolyte may be a sulfide glass, a crystalline sulfide glass (glass ceramic) or a crystalline material obtained by carrying out a solid-phase reaction treatment on the raw material composition.

The crystal state of the sulfide-based solid electrolyte can be confirmed, for example, by carrying out powder X-ray diffraction measurement using CuKα rays on the sulfide-based solid electrolyte.

The sulfide glass can be obtained by carrying out an amorphous treatment on the raw material composition such as a mixture of Li₂S and P₂S₅. As the amorphous treatment, examples include, but are not limited to, mechanical milling.

The glass ceramic can be obtained, for example, by heat-treating a sulfide glass.

The heat treatment temperature may be a temperature higher than the crystallization temperature (Tc) observed by thermal analysis measurement of the sulfide glass, and it is generally 195° C. or more. On the other hand, the upper limit of the heat treatment temperature is not particularly limited.

The crystallization temperature (Tc) of the sulfide glass can be measured by differential thermal analysis (DTA).

The heat treatment time is not particularly limited, as long as the desired crystallinity of the glass ceramic is obtained. For example, it is within a range of from one minute to 24 hours, and it may be within a range of from one minute to 10 hours.

The heat treatment method is not particularly limited. As the heat treatment method, examples include, but are not limited to, a heat treatment method using a firing furnace.

As the oxide-based solid electrolyte, examples include, but are not limited to, a substance having a garnet-type crystal structure including, for example, a Li element, a La element, an A element (A is at least one of Zr, Nb, Ta and Al), and an O element. The oxide-based solid electrolyte may be Li₃₊ₓPO₄₋ₓNₓ (1≤x≤3), for example.

The form of the solid electrolyte may be a particulate form, from the viewpoint of good handleability.

The average particle diameter (D50) of the solid electrolyte particles is not particularly limited. The lower limit of the average particle diameter may be 0.5 μm or more, and the upper limit may be 2 μm or less.

In the disclosed embodiments, the average particle diameter of the particles is the value of a volume-based median diameter (D50) measured by laser diffraction and scattering particle size distribution measurement, unless otherwise noted. In the disclosed embodiments, the median diameter (D50) is a diameter (volume average diameter) such that the cumulative volume of the particles is half (50%) of the total volume when the particles are arranged in order of particle diameter from smallest to largest.

The solid electrolyte may be one kind of solid electrolyte, or it may be 2 or more kinds of solid electrolytes. In the case of using 2 or more kinds of solid electrolytes, they may be mixed together, or they may be formed into a layer each to obtain a multilayer structure.

The amount of the solid electrolyte in the solid electrolyte layer is not particularly limited. For example, it may be 50% by mass or more; it may be within a range of 60% by mass or more and 100% by mass or less; it may be within a range of 70% by mass or more and 100% by mass or less; or it may be 100% by mass.

A binder may also be contained in the solid electrolyte layer, from the viewpoint of expressing plasticity, etc. As the binder, examples include, but are not limited to, materials that will be exemplified below as the binder used in the cathode layer described later. However, to facilitate high output, the binder contained in the solid electrolyte layer may be 5% by mass or less, from the viewpoint of preventing excessive aggregation of the solid electrolyte and enabling the formation of the solid electrolyte layer in which the solid electrolyte is uniformly dispersed.

The thickness of the solid electrolyte layer is not particularly limited, and it is generally 0.1 μm or more and 1 mm or less.

As the method for forming the solid electrolyte layer, examples include, but are not limited to, pressure molding a solid electrolyte material powder containing a solid electrolyte. In the case of pressure molding the solid electrolyte material powder, generally, a press pressure of about 1 MPa or more and 600 MPa or less is applied.

The method for applying the pressure is not particularly limited. As the method, examples include, but are not limited to, a pressure applying method exemplified later in the formation of the cathode layer.

### [Cathode]

The cathode includes the cathode layer. As needed, the cathode includes a cathode current collector.

### [Cathode Layer]

The cathode layer contains a cathode active material. As optional components, it may contain a solid electrolyte, a conductive material, a binder, etc.

There is no particular limitation on the type of the cathode active material, and any material which can be used as an active material of a solid battery can be employed. When the solid-state battery is a solid-state lithium secondary battery, as the cathode active material, examples include, but are not limited to, lithium metal (Li), a lithium alloy, LiCoO₂, LiNiₓCo₁₋ₓO₂ (0<x<1), LiNi_{1/3}Co_{1/3}Mn_{1/3}O₂, LiMnO₂, a different element-substituted Li—Mn spinel, lithium titanate, lithium metal phosphate, LiCoN, Li₂SiO₃, and Li₄SiO₄, a transition metal oxide, TiS₂, Si, SiO₂, and a lithium storage intermetallic compound. As the different element-substituted Li—Mn spinel, examples include, but are not limited to, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. As the lithium titanate, examples include, but are not limited to, Li₄Ti₅O₁₂. As the lithium metal phosphate, examples include, but are not limited to, LiFePO₄, LiMnPO₄, LiCoPO₄ and LiNiPO₄. As the transition metal oxide, examples include, but are not limited to, V₂O₅ and MoO₃. As the lithium storage intermetallic compound, examples include, but are not limited to, Mg₂Sn, Mg₂Ge, Mg₂Sb and Cu₃Sb. As the lithium alloy, examples include, but are not limited to, those exemplified above as the lithium alloy used for the anode active material.

The form of the cathode active material is not particularly limited. It may be a particulate form.

On the surface of the cathode active material, a coating layer containing a Li ion conductive oxide may be formed. This is because a reaction between the cathode active material and the solid electrolyte can be suppressed.

As the Li ion conductive oxide, examples include, but are not limited to, LiNbO₃, Li₄Ti₅O₁₂, and Li₃PO₄. The thickness of the coating layer is, for example, 0.1 nm or more, and it may be 1 nm or more. On the other hand, the thickness of the coating layer is, for example, 100 nm or less, and it may be 20 nm or less. The coating rate of the coating layer on the surface of the cathode active material is, for example, 70% or more, and it may be 90% or more.

As the solid electrolyte, examples include, but are not limited to, those exemplified above as the solid electrolyte that may be contained in the above-described solid electrolyte layer.

The amount of the solid electrolyte contained in the cathode layer is not particularly limited. It may be within a range of, for example, from 1% by mass to 80% by mass of the total mass (100% by mass) of the cathode layer.

As the conductive material, a known material can be used, such as a carbon material and metal particles. As the carbon material, examples include, but are not limited to, at least one selected from the group consisting of acetylene black, furnace black, VGCF, carbon nanotube and carbon nanofiber. Among them, at least one selected from the group consisting of VGCF, carbon nanotube and carbon nanofiber may be used, from the viewpoint of electronic conductivity. As the metal particles, examples include, but are not limited to, particles of Ni, Cu, Fe and SUS.

The amount of the conductive material contained in the cathode layer is not particularly limited.

As the binder, examples include, but are not limited to, acrylonitrile butadiene rubber (ABR), butadiene rubber (BR), polyvinylidene fluoride (PVdF) and styrene butadiene rubber (SBR). The amount of the binder contained in the cathode layer is not particularly limited.

The thickness of the cathode layer is not particularly limited.

The cathode layer can be formed by a conventionally known method.

For example, the cathode active material and, as needed, other components are put in a solvent; they are stirred to prepare a slurry for a cathode layer; and the slurry for the cathode layer is applied on one surface of a support such as a cathode current collector; and the applied slurry is dried, thereby obtaining the cathode layer.

As the solvent, examples include, but are not limited to, butyl acetate, butyl butyrate, heptane, and N-methyl-2-pyrrolidone.

The method for applying the slurry for the cathode layer on one surface of the support such as the cathode current collector, is not particularly limited. As the method, examples include, but are not limited to, the doctor blades method, the metal mask printing method, the static coating method, the dip coating method, the spread coating method, the roll coating method, the gravure coating method, and the screen printing method.

As the support, one having self-supporting property can be appropriately selected and used without particular limitation. For example, a metal foil such as Cu and Al can be used.

As another method for forming the cathode layer, the cathode layer may be formed by pressure molding a cathode mixture powder containing the cathode active material and, as needed, other components. In the case of pressure molding the cathode mixture powder, generally, a press pressure of about 1 MPa or more and 600 MPa or less is applied.

The method for applying the pressure is not particularly limited. As the method, examples include, but are not limited to, a pressure applying method using a plate press machine, a roll press machine, or the like.

### [Cathode Current Collector]

The solid-state battery generally includes the cathode current collector for current collection from the cathode layer.

As the cathode current collector, a known metal that can be used as the current collector of a solid-state battery, can be used. As the metal, examples include, but are not limited to, a metal material containing one or more elements selected from the group consisting of Cu, Ni, Al, V, Au, Pt, Mg, Fe, Ti, Co, Cr, Zn, Ge and In. As the cathode current collector, examples include, but are not limited to, SUS, aluminum, nickel, iron, titanium and carbon.

The form of the cathode current collector is not particularly limited. As the form, examples include, but are not limited to, various kinds of forms such as a foil form and a mesh form.

As needed, the solid-state battery includes an outer casing for housing the cathode layer, the anode layer, the solid electrolyte layer, etc.

The material for the outer casing is not particularly limited, as long as it is a material stable in electrolyte. As the material, examples include, but are not limited to, a resin such as polypropylene, polyethylene and acrylic resin.

The solid-state battery may be a primary battery, or it may be a secondary battery. Among them, the solid-state battery may be a secondary battery. A secondary battery is a battery which can be repeatedly charged and discharged, and it is useful as an in-vehicle battery, for example. The solid-state battery may be a solid-state lithium secondary battery.

As the form of the solid-state battery, examples include, but are not limited to, a coin form, a laminate form, a cylindrical form and a square form.

The solid-state battery of the disclosed embodiments may be produced by the following method, for example. First, the solid electrolyte layer is formed by pressure molding the solid electrolyte material powder. Next, the cathode layer is obtained by pressure molding the cathode mixture powder containing the cathode active material on one surface of the solid electrolyte layer. Then, the anode layer is obtained by pressure molding the anode material powder on one surface of the anode current collector. On a surface of the solid electrolyte layer, which is opposite to the surface on which the cathode layer is formed, an assembly of the anode current collector and the anode layer is attached so that the anode layer is in contact with the solid electrolyte layer. Then, as needed, the cathode current collector is attached on a surface of the cathode layer, which is opposite to the solid electrolyte layer. Accordingly, the solid-state battery of the disclosed embodiments is obtained.

In this case, the press pressure applied for pressure-molding the anode material powder, the solid-state electrolyte material powder and the cathode mixture powder is generally about 1 MPa or more and 600 MPa or less.

The method for applying the pressure is not particularly limited. As the method for applying the pressure, examples include, but are not limited to, the method described above in the formation of the cathode layer.

### EXAMPLES

### Example 1

### [Anode Material]

A multiphase alloy foil was prepared as follows as an anode material. A Li—Al multiphase alloy was injection molded, and the injection molded alloy was rolled to a thickness of 100 μm by roll pressing, thereby obtaining the multiphase alloy foil. The amount of Al in the Li—Al multiphase alloy was 0.96% by mass. This fact corresponds to that the Al in the Li—Al multiphase alloy is 0.25 atomic %.

An oxide film on the surface of the Li—Al multiphase alloy foil was removed in an Ar-filled glove box. Next, the Li—Al multiphase alloy foil was rolled to a thickness of 80 μm by a roller. Then, the Li—Al multiphase alloy foil was left in a dry atmosphere glove box controlled to a dew point of −30° C. for 24 hours, and it was regarded as the Li—Al multiphase alloy foil exposed to the dry atmosphere. As a comparison, a Li—Al multiphase alloy foil having the same configuration was left in an Ar atmosphere glove box for 24 hours, and it was regarded as the Li—Al multiphase alloy foil exposed to the Ar atmosphere.

### [Preparation of Evaluation Cells]

The following operations were carried out in an Ar-filled glove box.

The Li—Al multiphase alloy foil exposed to the dry atmosphere was formed into a 1 cm² circle.

A Li₂S—P₂S₅-based material was used as a sulfide-based solid electrolyte. The sulfide-based solid electrolyte, which was in a powder form, was placed in a 1 cm² MACOR cell and pressed to obtain a solid electrolyte layer.

As a cathode active material, a sulfur mixture powder equivalent to a capacity of 4.56 mAh was placed in the MACOR cell and pressed to form a cathode layer on a solid electrolyte layer.

As the anode material, the Li—Al multiphase alloy foil exposed to the dry atmosphere was placed in the MACOR cell to form an anode layer on the solid electrolyte layer. As an anode current collector, a Ni foil was placed on the anode layer in the MACOR cell and pressed. Thus, a pressed powder battery having the cathode layer, the solid electrolyte layer, the anode layer and the anode current collector in this order, was obtained.

The pressed powder battery was constrained at 2 Nm to obtain an evaluation cell (A).

An evaluation cell (a) was prepared to compare its capacity retention rates before and after exposed to a dry atmosphere. The evaluation cell (a) was obtained in the same manner as the evaluation cell (A), except that as the anode material, the Li—Al multiphase alloy foil exposed to the Ar atmosphere was used instead of the Li—Al multiphase alloy foil exposed to the dry atmosphere.

### Example 2

A Li—Al multiphase alloy in which the amount of Al was 3.00% by mass, was used as an anode material. The fact that the amount of the Al in the Li—Al multiphase alloy is 3.00% by mass, corresponds to that the Al in the Li—Al multiphase alloy is 0.79 atomic %. Except for this, in the same manner as Example 1, an evaluation cell (B) using a Li—Al multiphase alloy foil exposed to a dry atmosphere was obtained, and an evaluation cell (b) using a Li—Al multiphase alloy foil exposed to an Ar atmosphere was obtained.

### Example 3

A Li—Al multiphase alloy in which the amount of Al was 20.16% by mass, was used as an anode material. The fact that the amount of the Al in the Li—Al multiphase alloy is 20.16% by mass, corresponds to that the Al in the Li—Al multiphase alloy is 6.10 atomic %. Except for this, in the same manner as Example 1, an evaluation cell (C) using a Li—Al multiphase alloy foil exposed to a dry atmosphere was obtained, and an evaluation cell (c) using a Li—Al multiphase alloy foil exposed to an Ar atmosphere was obtained.

### Example 4

A Li—In multiphase alloy in which the amount of In was 0.99% by mass, was used as an anode material. The fact that the amount of the In in the Li—In multiphase alloy is 0.99% by mass, corresponds to that the In in the Li—In multiphase alloy is 0.06 atomic %. Except for this, in the same manner as Example 1, an evaluation cell (D) using a Li—In multiphase alloy foil exposed to a dry atmosphere was obtained, and an evaluation cell (d) using a Li—In multiphase alloy foil exposed to an Ar atmosphere was obtained.

### Example 5

A Li—In multiphase alloy in which the amount of In was 3.00% by mass, was used as an anode material. The fact that the amount of the In in the Li—In multiphase alloy is 3.00% by mass, corresponds to that the In in the Li—In multiphase alloy is 0.19 atomic %. Except for this, in the same manner as Example 1, an evaluation cell (E) using a Li—In multiphase alloy foil exposed to a dry atmosphere was obtained, and an evaluation cell (e) using a Li—In multiphase alloy foil exposed to an Ar atmosphere was obtained.

### Example 6

A Li—In multiphase alloy in which the amount of In was 10.00% by mass, was used as an anode material. The fact that the amount of the In in the Li—In multiphase alloy is 10.00% by mass, corresponds to that the In in the Li—In multiphase alloy is 0.67 atomic %. Except for this, in the same manner as Example 1, an evaluation cell (F) using a Li—In multiphase alloy foil exposed to a dry atmosphere was obtained, and an evaluation cell (f) using a Li—In multiphase alloy foil exposed to an Ar atmosphere was obtained.

### Example 7

A Li—In multiphase alloy in which the amount of In was 20.02% by mass, was used as an anode material. The fact that the amount of the In in the Li—In multiphase alloy is 20.02% by mass, corresponds to that the In in the Li—In multiphase alloy is 1.50 atomic %. Except for this, in the same manner as Example 1, an evaluation cell (G) using a Li—In multiphase alloy foil exposed to a dry atmosphere was obtained, and an evaluation cell (g) using a Li—In multiphase alloy foil exposed to an Ar atmosphere was obtained.

### Example 8

A Li—Zn multiphase alloy in which the amount of Zn was 0.93% by mass, was used as an anode material. The fact that the amount of the Zn in the Li—Zn multiphase alloy is 0.93% by mass, corresponds to that the Zn in the Li—Zn multiphase alloy is 0.10 atomic %. Except for this, in the same manner as Example 1, an evaluation cell (H) using a Li—Zn multiphase alloy foil exposed to a dry atmosphere was obtained, and an evaluation cell (h) using a Li—Zn multiphase alloy foil exposed to an Ar atmosphere was obtained.

### Example 9

A Li—Zn multiphase alloy in which the amount of Zn was 3.00% by mass, was used as an anode material. The fact that the amount of the Zn in the Li—Zn multiphase alloy is 3.00% by mass, corresponds to that the Zn in the Li—Zn multiphase alloy is 0.33 atomic %. Except for this, in the same manner as Example 1, an evaluation cell (I) using a Li—Zn multiphase alloy foil exposed to a dry atmosphere was obtained, and an evaluation cell (i) using a Li—Zn multiphase alloy foil exposed to an Ar atmosphere exposure was obtained.

### Example 10

A Li—Zn multiphase alloy in which the amount of Zn was 10.27% by mass, was used as an anode material. The fact that the amount of the Zn in the Li—Zn multiphase alloy is 10.27% by mass, corresponds to that the Zn in the Li—Zn multiphase alloy is 1.20 atomic %. Except for this, in the same manner as Example 1, an evaluation cell (J) using a Li—Zn multiphase alloy foil exposed to a dry atmosphere was obtained, and an evaluation cell (j) using a Li—Zn multiphase alloy foil exposed to an Ar atmosphere was obtained.

### Comparative Example 1

An evaluation cell (K) using a Li foil exposed to a dry atmosphere and an evaluation cell (k) using a Li foil exposed to an Ar atmosphere were obtained in the same manner as Example 1, except that Li was used as the anode material.

### [Evaluation of the Discharge of the Evaluation Cells]

The evaluation cell (A) was placed in a separable flask, and the separable flask was sealed. The evaluation cell (A) was left to stand in a constant temperature bath at 60° C. for 3 hours to equalize the temperature in the evaluation cell (A). Then, the evaluation cell (A) was discharged at a constant current of 0.1 C at 0.456 mAh per cm², and the discharge was terminated when the voltage of the evaluation cell (A) reached 2 V. The discharge capacity (mAh per cm²) of the battery exposed to the dry atmosphere (hereinafter, it may be referred to as “dry atmosphere exposed discharge capacity”) was measured.

The evaluation cell (a) was discharged in the same manner as the evaluation cell (A), and the discharge capacity (mAh per cm²) of the battery exposed to the Ar atmosphere (hereinafter, it may be referred to as “Ar atmosphere exposed discharge capacity”) was measured. The capacity retention rate of the battery exposed to the dry atmosphere (hereinafter, it may be referred to as “dry atmosphere exposed capacity retention rate”) was calculated from the dry atmosphere exposed discharge capacity and the Ar atmosphere exposed discharge capacity by the following formula. The result is shown in Table 1.

Dry atmosphere exposed capacity retention rate (%)=100×(Dry atmosphere exposed discharge capacity/Ar atmosphere exposed discharge capacity)

The evaluation cells (B) to (K) and the evaluation cells (b) to (k) were discharged in the same manner as the evaluation cells (A) and (a), and the dry atmosphere exposed capacity retention rates thereof were calculated. The results are shown in Table 1.

TABLE 1

| | | | | Dry |
|---|---|---|---|---|
| | | | | atmosphere |
| | | | | exposed |
| | | M | M | capacity |
| | | (% by | (atomic | retention |
| | M | mass) | %) | rate (%) |
| Comparative | — | — | — | 22 |
| Example 1 | | | | |
| Example 1 | Al | 0.96 | 0.25 | 62 |
| Example 2 | Al | 3.00 | 0.79 | 84 |
| Example 3 | Al | 20.16 | 6.10 | 100 |
| Example 4 | In | 0.99 | 0.06 | 60 |
| Example 5 | In | 3.00 | 0.19 | 92 |
| Example 6 | In | 10.00 | 0.67 | 100 |
| Example 7 | In | 20.02 | 1.50 | 90 |
| Example 8 | Zn | 0.93 | 0.10 | 90 |
| Example 9 | Zn | 3.00 | 0.33 | 66 |
| Example 10 | Zn | 10.27 | 1.20 | 60 |

### [Evaluation Results]

For the evaluation cell of Comparative Example 1, which is the battery using the Li foil, the dry atmosphere exposed capacity retention rate was 22%.

For the evaluation batteries of Examples 1 to 10, which are the batteries using the multiphase alloy foils, the dry atmosphere exposed capacity retention rates are better as compared with the evaluation cell using the Li foil.

In the case where the M of the multiphase alloy was Al, the dry atmosphere exposed capacity retention rate was the maximum when the Al contained in the multiphase alloy was 6.10 atomic %, and the dry atmosphere exposed capacity retention rate was 100%.

In the case where the M of the multiphase alloy was In, the dry atmosphere exposed capacity retention rate was the maximum when the In contained in the multiphase alloy was 0.67 atomic %, and the dry atmosphere exposed capacity retention rate was 100%.

In the case where the M of the multiphase alloy was Zn, the dry atmosphere exposed capacity retention rate was the maximum when the Zn contained in the multiphase alloy was 0.10 atomic %, and the dry atmosphere exposed capacity retention rate was 90%.

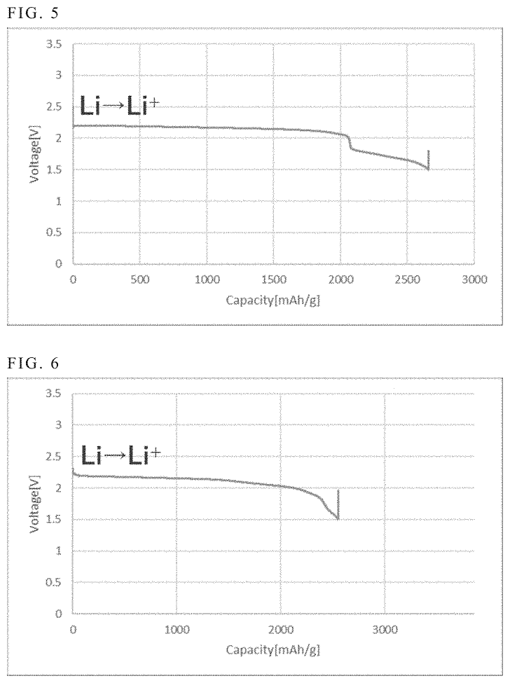

FIG. 5 is an example of the discharge curve of the evaluation cell (C) in which the Li—Al multiphase alloy of Example 3 was used as the anode. For the Li—Al multiphase alloy, the phase diagram of FIG. 1 indicates that in the structure of the Li, Li₉Al₄ is slightly contained as a Li—Al alloy phase. As shown in FIG. 5, the Li₉Al₄ is 0.6 V lower than the Li potential, and in the evaluation cell (C), charging and discharging proceed at the potential at which Li⁺ desorbs from Li. Accordingly, in a capacity range of from 0 mAh/g to 2000 mAh/g, the Li₉Al₄ does not make a contribution to charging and discharging.

FIG. 6 is an example of the discharge curve of the evaluation cell (F) in which the Li—In multiphase alloy of Example 6 was used as the anode. For the Li—In multiphase alloy, the phase diagram of FIG. 2 indicates that in the structure of the Li, InLi is slightly contained as a Li—In alloy phase. As shown in FIG. 6, a reaction potential derived from the In is not visible since the amount of the In is too small. In the evaluation cell (F), charging and discharging proceed at the potential at which Li⁺ desorbs from Li, and the InLi does not make a contribution to charging and discharging.

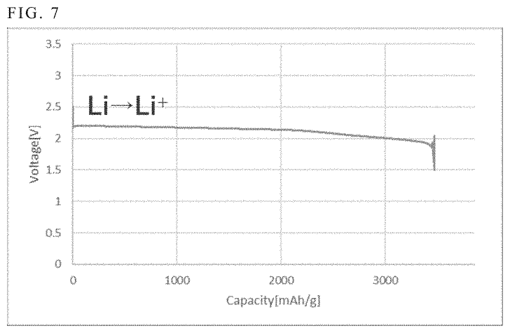

FIG. 7 is an example of the discharge curve of the evaluation cell (H) in which the Li—Zn multiphase alloy of Example 8 was used as the anode. For the Li—Zn multiphase alloy, the phase diagram of FIG. 3 indicates that in the structure of the Li, LiZn is slightly contained as a Li—Zn alloy phase. As shown in FIG. 7, a reaction potential derived from the Zn is not visible since the amount of the Zn is too small. In the evaluation cell (H), charging and discharging proceed at the potential at which Li⁺ desorbs from Li, and the LiZn does not make a contribution to charging and discharging.

### REFERENCE SIGNS LIST

11: Anode current collector
12: Solid electrolyte layer
13: Cathode layer
14: Cathode current collector
15: Anode layer
100: Solid-state battery

1. An anode material for solid-state batteries that use a precipitation-dissolution reaction of lithium metal as an anode reaction,
wherein the anode material is a multiphase alloy comprising a Li single phase and a Li-M alloy phase;
wherein M of the Li-M alloy phase is at least one metal selected from the group consisting of Al, In and Zn; and
wherein an amount of the M in the multiphase alloy is 0.90% by mass or more and 21.00% by mass or less.

2. The anode material according to claim 1, wherein the M includes Al, and wherein the Al in the multiphase alloy is 0.25 atomic % or more and 6.10 atomic % or less.

3. The anode material according to claim 1, wherein the M includes In, and wherein the In in the multiphase alloy is 0.06 atomic % or more and 1.50 atomic % or less.

4. The anode material according to claim 1, wherein the M includes Zn, and wherein the Zn in the multiphase alloy is 0.10 atomic % or more and 1.20 atomic % or less.

5. A solid-state battery that uses a precipitation-dissolution reaction of lithium metal as an anode reaction, the solid-state battery comprising a cathode comprising a cathode layer, an anode comprising an anode current collector and an anode layer, and a solid electrolyte layer disposed between the cathode layer and the anode layer,
wherein the anode layer comprises an anode material that is a multiphase alloy comprising a Li single phase and a Li-M alloy phase;
wherein M of the Li-M alloy phase is at least one metal selected from the group consisting of Al and In and Zn; and
wherein an amount of the M in the multiphase alloy is 0.90% by mass or more and 21.00% by mass or less when the solid-state battery is fully charged.
